(19) United States
(12) Patent Application Publication
(10) Pub. No.: US 2007/0018006 A1
(43) Pub. Date: Jan. 25, 2007

(54) Return manifold with self-regulating valve

(76) Inventors: Robert J. Monson, St. Paul, MN (US); John P. Abraham, Minneapolis, MN (US)

Correspondence Address: HAMRE, SCHUMANN, MUELLER & LARSON, P.C., P.O. BOX 2902, MINNEAPOLIS, MN, 55402-0902, US

(21) Appl. No.: 11/187,211

(22) Filed: Jul. 22, 2005

(51) Int. Cl. G05D 23/02

(52) U.S. Cl. 236/93 R

(57) ABSTRACT

A return manifold includes a self-regulating valve that operates to control the free flow of fluidic medium in such a way that greater cooling/heating is directed to those paths requiring more or less heat removal. The return manifold can be configured to be operational solely by the temperature of the fluidic medium passing through the self-regulating valve.

### BACKGROUND OF THE INVENTION

1. Field of the Invention

This invention relates generally to cooling and heating system components, and more particularly to a return manifold with a self-regulating valve for use in passively or actively temperature controlled, self-regulating cooling and heating systems for cooling or heating a liquid, gas, or phase transition medium to implement selective cooling of an operationally hot system or device, or selective heating of an operationally cold system or device in the same manner, to increase the system or device operating efficiency.

2. Description of the Prior Art

The return fluid from a cooling system is typically returned to a tank or supply area by means of free flow. This technique does not allow direct control of differential flow of cooling fluid into areas of greater need in certain enclosures, for example, except by direct valving or orifice control. Further, this technique does not allow a self-configuring action to take place.

Known cooling/heating techniques are capable of providing desired efficiencies, but often at cost parameters that are simply non-competitive in the modern marketplace. Modern electronic systems and devices run at faster operating speeds when properly cooled; and the expected system or device life is increased when operating temperatures are properly managed.

Certain radar displays, for example, are very large, and for strategic reasons that may be related to the operational environment and the like, require passive cooling techniques. Since these arrays are so very large, only certain portions of such displays are used at any given moment in time. It is therefore not efficient to cool the whole radar array associated with the radar display unit, when instead, it is only necessary to cool that portion of the array that is being utilized, and thus is operating at an elevated temperature.

Consider now an array 10 having four sections such as shown in FIGS. 1A, 1B and 1C. In FIG. 1A, array 10 can be seen to exhibit section temperatures of 50° F. and 200° F. in the upper two sections from left to right respectively; while the lower two sections exhibit section temperatures of 60° F. and 50° F. from left to right respectively. Consider now also a convective cooling system; If a conventional uniform cooling approach is utilized to cool the array 10, only 25% of the coolant may come into contact with the hot 200° F. area, quickly reaching the maximum heat flux of the cooling system. Thus, as seen in FIG. 1B, the hot 200° F. area may cool down to only 150° F. Although better, the efficiency of uniform cooling falls short of the desired results. Consider now instead, a cooling system that directs 75% of the coolant fluid through the hot 200° F. zone, with the remaining 25% used for the other zones. Such a cooling system can be expected to extract heat more efficiently. Smart cooling therefore, results in a more efficient transfer of thermal energy to yield the array temperatures depicted in FIG. 1C.

In view of the foregoing background, it would be extremely beneficial and advantageous to provide a return manifold that operates to control the aforesaid free flow of the coolant/heating medium in such a way that greater cooling/heating is directed to those paths requiring more or less heat removal. It would be further beneficial if the return manifold could be operational solely by the temperature of the fluidic medium passing through the return manifold.

### SUMMARY OF THE INVENTION

The present invention is directed to a return manifold that is configured to control the free flow of fluidic medium passing through the return manifold. The return manifold includes one or more thermal gates that operate to increase or decrease the back pressure on the cooling/heating system for those fluid paths not requiring as much cooling or heating. The increase or decrease in back pressure forces more or less fluidic medium through the fluidic paths of free flow, resulting in a greater or lesser cooling of those paths requiring more or less heat removal. The free flow of fluidic medium passing through the return manifold is thus most preferably controlled solely by the temperature of the fluid passing through the return gate(s). The thermal gate(s) can operate passively solely in response to the fluidic temperature to vary the size of the gate orifice, or can operate via an active control system or device to vary the size of the gate orifice in response to the fluidic temperature.

The return manifold is suitable to implement a passive or active, self-regulating cooling and/or heating system to achieve a desired level of operating efficiency at a minimized cost level when compared with known cooling/heating systems and methods. The return manifold can direct a cooling/heating medium, e.g. liquid, gas, medium that changes state or undergoes a phase transition, through only those portions of a system or device that are operationally hot or cold, while substantially ignoring those portions of the system or device that are not operationally hot or cold or are otherwise operationally cool or hot.

More specifically, one embodiment of the return manifold comprises a plurality of input ports configured to receive fluidic coolant or heating medium that is exhausted from predetermined sections of a system or device to be environmentally controlled. Each input port most preferably receives the fluidic coolant or heating medium solely from a predetermined single section. The manifold has a single output port that transfers the fluidic medium into a heat exchanger wherein the fluidic medium is cooled or heated as necessary. The fluidic medium is then pumped back into the system or device. Each manifold input can contain a distinct passive or active temperature controlled thermal gate that reacts only to the temperature of the fluidic medium passing through the passive or active thermal gate. In this manner, each section or portion of the device or system to be cooled will receive only that amount of fluidic medium necessary to efficiently cool or heat the respective section or portion that needs to be cooled/heated. This process then can be seen to be self-regulating since each passive or active thermal gate reacts to pass or restrict the amount of fluidic medium passing through its respective section or portion of the system or device. The operating efficiency is thus improved since the maximum quantity of fluidic medium returned need not necessarily pass through each portion of the device or system to be environmentally controlled only those sections or portions requiring enhanced cooling/heating will see enhanced/decreased medium flow there through.

In one aspect of the invention, a return manifold includes a plurality of input ports; at least one output port; and at least one self-regulating thermal gate operational to modify the transfer rate of a fluidic medium passing through the return manifold.

The self-regulating thermal gate is most preferably a passively controlled device, but could just as easily be an actively controlled device, that operates most preferably in response to temperature changes associated with the fluidic medium to regulate the amount of fluidic medium flowing through selected portions or sections of the environmentally controlled system or device. A suitable self-regulating thermal gate may comprise a variable orifice valve, for example, in which the size of the orifice is controlled via a thermal element such as a thermally responsive spring.

### BRIEF DESCRIPTION OF THE DRAWINGS

Other aspects, features and advantages of the present invention will be readily appreciated as the invention becomes better understood by reference to the following detailed description when considered in connection with the accompanying drawing figures wherein:

FIG. 1A depicts a system or device array having four distinct heat/cool zones;

FIG. 1B shows the temperature effects of uniform cooling applied to the distinct heat/cool zones depicted in FIG. 1A;

FIG. 1C shows the temperature effects of smart cooling applied to the distinct heat/cool zones depicted in FIG. 1A;

FIG. 2A is a simplified system diagram illustrating a self-regulating cooling system according to one embodiment of the present invention;

FIG. 2B is an exploded view showing more details of the return manifold depicted in FIG. 2A;

FIG. 3 is a flow diagram illustrating a method of cooling a system or device according to one embodiment of the present invention; and

FIG. 4 illustrates a self-regulating thermal gate in a return manifold with an active control unit according to one embodiment of the present invention.

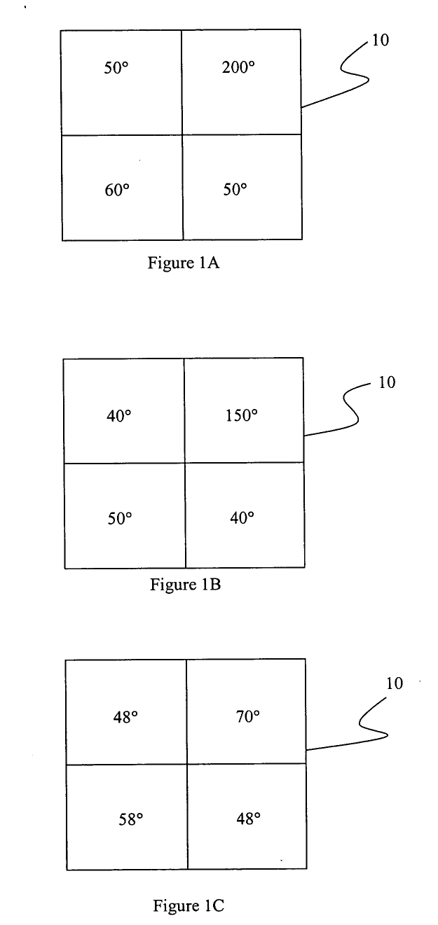

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

The embodiments described in detail herein below are directed to a return manifold having one or more self-regulating thermal gates. The return manifold can modify a cooling (or heating) system to passively or actively provide a desired level of operating efficiency at a minimized cost level when compared with known cooling and heating systems and methods that employ free flow techniques. The return manifold, as stated herein before, can direct a cooling or heating (fluidic) medium, e.g. liquid, gas, medium that changes state or undergoes a phase transition, through only those portions of a system or device that are operationally hot or cold, while substantially ignoring those portions of the system or device that are not operationally hot or cold or are otherwise operationally cool or hot.

Before moving to the Figures, it is important to note that the return manifold, in contradistinction with a free flow system, modifies a system or device to be environmentally controlled in a manner that allows cooling or heating of system or device sections or portions that are independent from one another such that it is possible to selectively cool or heat any one or more sections or portions. One embodiment, as stated herein before, exhausts the fluidic medium from each section of the system or device into a manifold having a plurality of input ports. Each input port receives the fluidic medium solely from a predetermined single section. The manifold may have one or more output ports that transfer the fluidic medium into a heat exchanger, for example, where the fluidic medium temperature is altered. In systems and/or devices that may run too cold, the process can be easily modified such that a liquid, gas, or phase transition medium is heated or has a desired level of reduced cooling. Subsequent to cooling/heating, the cooled/heated fluidic medium is then pumped back into the system or device. Each manifold input can contain a distinct passive or active thermal gate that reacts only to the temperature of the cooling/heating fluidic medium passing through the distinct thermal gate. In this manner, each section or portion of the device or system to be environmentally controlled will receive only that amount of cooling/heating fluidic medium necessary to efficiently cool or heat the respective section or portion that needs to be cooled or heated. This process then can be seen to be self-regulating since each passive or active, self-regulating thermal gate reacts to pass or restrict the amount of coolant or heating medium passing through its respective section or portion of the system or device, focusing on maximum efficiency i.e. maximum output for a given minimum input. The operating efficiency is thus improved since the maximum quantity of return coolant or heating medium need not necessarily pass through all portions of the device or system to be cooled or heated only those sections or portions requiring enhanced cooling will see enhanced coolant while those section or portions requiring enhanced heating will see less coolant flow there through respectively.

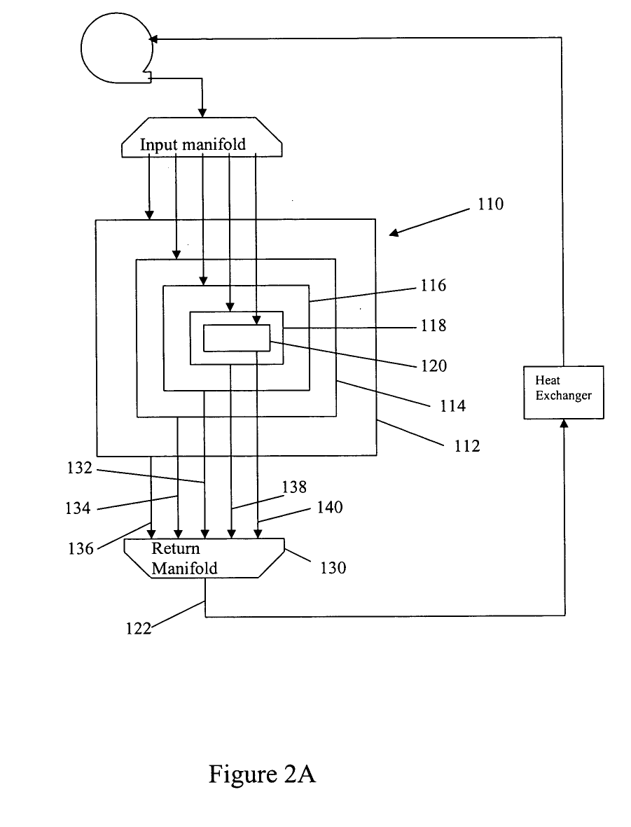

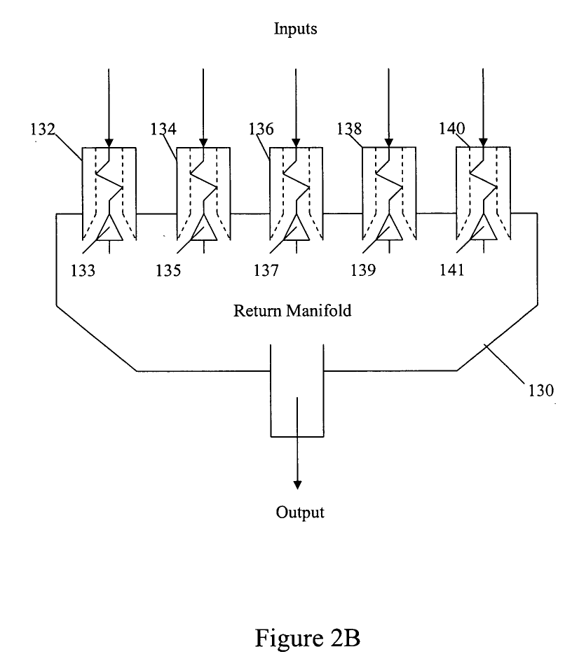

Looking now at FIG. 2A, a simplified block diagram illustrates a self-regulating cooling/heating system 100 according to one embodiment of the present invention. Self-regulating cooling/heating system 100 operates to cool or heat selected portions 112, 114, 116, 118, 120 of a heat generating system such as a radar array 110. Each portion 112-120 of the radar array 110 is cooled or heated independently of any other portion as now described below. Self-regulating cooling/heating system 100 can be seen to include a return manifold 130 having a plurality of input ports 132, 134, 136, 138, 140. Each input port 132-140 is connected to a single unique portion or section 112-120 of the radar array 110. Manifold 130 can be seen to also have a single output port 122. Cooling/heating system 100 has a heat transfer device such as a heat exchanger, that operates to cool or heat the coolant or heating medium that is employed to cool or heat the sections of the radar array 110. Any suitable coolant or heating medium such as a liquid medium, gaseous medium, or coolant/heating medium, such as, but not limited to Freon, that changes state in response to temperature changes, can be employed, so long as the desired heat transfer characteristics are achieved. The heat exchanger has a single input port that receives coolant/heating medium from the single output port 122 of the manifold 130. Subsequent to cooling or heating, the coolant or heating medium is exhausted via a single heat exchanger output port wherein the coolant or heating medium is redirected back to any coolant/heating medium input port(s) associated with the radar array 110.

Looking now at FIG. 2B, each of the return manifold 130 input ports 132, 134, 136, 138, 140 can be seen to most preferably employ a passive self-regulating thermal gate 133, 135, 137, 139, 141. Each passive self-regulating thermal gate 133-141 may, for example, comprise a variable orifice valve in which the orifice increasingly opens or closes in response to changes in the temperature of the fluidic medium passing through the thermal gate. In this manner, each variable orifice valve will continue to successfully operate, even in the absence of any type of active control, such as that which may be provided via a computerized control unit or system. The present invention is not so limited however, and it shall be understood that an actively controlled self-regulating thermal gate can also be employed to implement the smart environmental control described herein and thus provide the desired system or device operating efficiencies.

In further explanation, and with continued reference now to FIG. 2B, a self-regulating cooling/heating system 100 can be seen to comprise a return manifold 130 and at least one self-regulating thermal gate 133, 135, 137, 139, 141, to cool or heat selected portions of a device or system (e.g. radar array) 110. A suitable coolant or heating medium which may be in the form of a gas, liquid, or medium that undergoes a phase transition during the heat transfer process, passes through each section of the device or system (e.g. radar array) 110. Only certain portions or sections 112, 114, 116, 118, 120, of the array 110 may be operational at any given time; thus only those sections that are operational may have a need to be cooled or heated. Further, some sections of the array 110 may operate hotter or cooler than other sections of the array 110, thus demanding more or less coolant or heating medium flow to achieve a desired cooling or heating effect. Coolant or heating medium is exhausted from each section of the radar array 110 into a unique input port of the return manifold 130, wherein a self-regulating thermal gate 133, 135, 137, 139, 141, monitors the temperature of the exhausted coolant or heating medium. If the fluidic medium temperature is too high, the respective self-regulating thermal gate will operate in a non-restrictive mode to increase the size of an orifice that allows more of the coolant to pass through its associated section of the array 110 and quickly return that respective array section to a suitable operating temperature. If the fluidic temperature is not too high, the respective self-regulating thermal gate will operate in its restrictive mode to decrease the size of the orifice to decrease the amount of coolant passing through its associated section of the array 110. The self-regulating thermal gates 133, 135, 137, 139, 141 will operate continuously to variably increase and decrease the respective orifice openings in response to individual array section coolant temperatures to maintain a desired and substantially constant range or operational array temperatures. Alternatively, if the fluidic temperature is too low, the respective self-regulating thermal gate will operate in a restrictive mode to decrease the size of an orifice to allow less coolant to pass through its associated section of the array 110, quickly returning that respective array section to a more suitable operating temperature.

Those skilled in the cooling and heating system arts will readily appreciate that the cooling principles described herein can just as easily be inversely applied to provide desired heating effects. Thus, a particular section of a system or device that may be operating too cool, may be more efficiently heated to a more suitable operating temperature by directing a larger percentage of a heating medium through that section, or alternatively, as described herein before, by directing a smaller percentage of a cooling medium through that section. In this manner, the overall system or device operating efficiency can thus be optimized by using a smart environmental control system rather than a more conventional uniform free flow system that is familiar to those skilled in the heating art.

Each self-regulating thermal gate, as stated herein before, may be passively controlled or controlled via an active controller of some type. Passive control is most preferred, since the passive, self-regulating thermal gate will continue to function in its normal temperature sensing mode to control the size of the variable orifice regardless of whether the control system or device remains operational. Further, as stated herein before, the inverse principles easily apply to implement a self-regulating heating system in contradistinction to the self-regulating cooling system principles described in detail herein before.

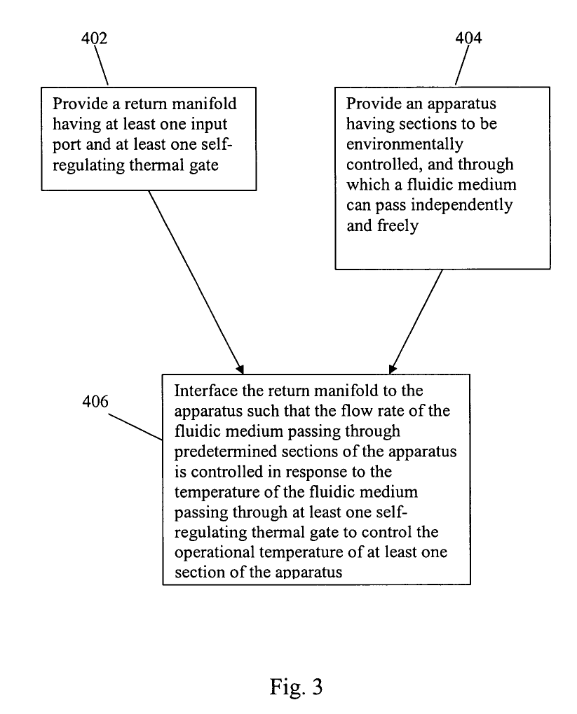

FIG. 3 is a flow diagram illustrating a method 400 of cooling or heating sections or portions of a system or device according to one embodiment of the present invention. Method 400 is implemented by first providing a return manifold having at least one input port, but most preferably a plurality of input ports, and wherein the return manifold includes at least one a self-regulating thermal gate disposed therein, as shown in block 402; and also providing as shown in block 404, a system or device such as a radar display (herein after referred to as apparatus) having sections or portions to be cooled or heated, and that is configured such that a coolant or heating medium can pass independently and freely through selected sections or portions of the system or device to be cooled or heated. The return manifold is then interfaced to the selected apparatus sections or portions to be cooled/heated such that the flow rate of fluidic medium passing through each selected or predetermined section is most preferably passively controlled in response to the temperature of the fluidic medium passing through at least one thermal gate and/or selected sections and/or portions of the apparatus to be cooled/heated, as shown in block 406.

The self-regulating thermal gate, as stated herein before, may be implemented, for example by, but not limited to, a passively controlled variable orifice valve. The valve may include a thermal spring element immersed in the coolant or heating medium (fluidic medium) such that the thermal spring operates in response to a temperature differential to variably open and close the valve orifice to control the rate of coolant or heating (fluidic) medium passing through the valve orifice. The self-regulating thermal gate can be placed within predetermined portions of the return manifold 130 itself, or alternatively, within predetermined portions of the system or device to be cooled/heated, such as discussed in detail herein before. As also stated herein before, the self-regulating thermal gate may optionally be an actively controlled element.

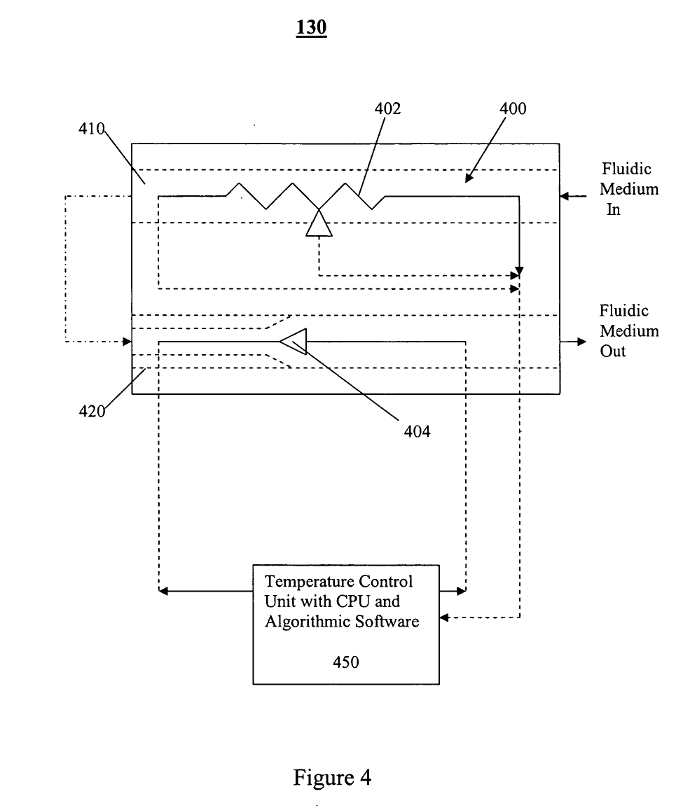

FIG. 4 illustrates a manifold portion 130 of a cooling/heating system 100 with an actively controlled self-regulating temperature sensing thermal gate 400 according to one embodiment of the present invention. The actively controlled self-regulating temperature sensing thermal gate 400 can be seen to have a thermal sensing wire spring 402 strategically positioned within one of the manifold 130 input ports 410, while an associated plunger unit 404 is strategically positioned within a different manifold input port 420. It shall be understood that such active sensing element control can be applied to any embodiment described herein before in which only passive control principles were discussed. A computerized control unit 450 having requisite algorithmic software monitors a change in resistance of the thermal sensing wire spring 402 as fluidic medium passes over the thermal sensing wire spring 402. A control signal from the computerized control unit 450 that is responsive to this change in resistance is sent to the plunger unit 404 to vary the movement of the plunger unit 404. Movement of the plunger unit 404 then operates in response to this control signal to vary the amount of coolant or heating medium passing through the second manifold through port 420. This invention is not so limited however, and it shall be understood that the thermal sensing wire spring 402 and the plunger unit 404 can just as easily be disposed together within a single manifold input or output port to implement a return manifold with a self-regulating valve in accordance with the principles described in detail herein before.

In summary explanation, the return fluid from a cooling system is typically returned to a tank or supply area by means of free flow. This does not allow direct control of differential flow of cooling fluid into areas of greater need in enclosures and the like except by direct valving or orifice control. Self-regulating action is thus not allowed to take place. If the free flow of the fluid was controlled by means of a thermal gate, the return manifold would increase the back pressure on the cooling system for those fluid paths not requiring as much cooling. This would force additional cooling fluid across the fluid paths of free flow, resulting in a greater cooling of those paths requiring more heat removal. This would be controlled by the temperature of the fluid passing through the return gate. The foregoing solution provides a self-regulating capacity not presently available in the industry without expensive flow control feedback systems. This system will, in contradistinction with presently available systems, most preferably operate passively and accomplish the same result. The present invention is not so limited however, and the self-regulating concepts described herein before with reference to the present return manifold may also be implemented using actively controlled self-regulating thermal gates, as stated herein before.

In view of the above, it can be seen the present invention presents a significant advancement in the art of cooling and heating system manifold design. Further, this invention has been described in considerable detail in order to provide those skilled in the heat transfer arts with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow. The return manifold, for example, may employ any number of different manifold configurations, so long as cooling or heating for the system or device to be environmentally controlled is self-regulating and passively or actively controlled in accordance with the principles described herein before. Further, the requisite self-regulating thermal gates employed may be placed in any variety of appropriate locations to implement individual section cooling and/or heating to passively or actively achieve the desired self-regulating sectional cooling and/or heating in response to particular system or device cooling or heating medium temperature(s)

What is claimed is:

1. A return manifold comprising:
at least one input port;
at least one output port; and
at least one self-regulating thermal gate disposed within the return manifold to control the flow rate of a fluidic medium flowing there through.

2. The return manifold according to claim 1, wherein the at least one self-regulating thermal gate is a passively controlled device that is responsive solely to temperature changes in a fluidic medium passing through the return manifold.

3. The return manifold according to claim 1, wherein the at least one self-regulating thermal gate is an actively controlled device that is responsive to temperature changes in a fluidic medium passing through the return manifold.

4. The return manifold according to claim 1, wherein the fluidic medium comprises a liquid.

5. The return manifold according to claim 1, wherein the fluidic medium comprises a gas.

6. The return manifold according to claim 1, wherein the fluidic medium comprises a substance that undergoes a phase transition during a heat transfer cycle.

7. The return manifold according to claim 1, wherein the at least one self-regulating thermal gate is operational in response to the fluidic medium temperature passing through the thermal gate to control the transfer rate of fluidic medium flowing through the return manifold.

8. The return manifold according to claim 1, wherein the at least one self-regulating thermal gate is a variable orifice valve.

9. The return manifold according to claim 1, wherein the at least one self-regulating thermal gate is disposed within at least one input port.

10. The return manifold according to claim 1, wherein the at least one self-regulating thermal gate is disposed within at least one output port.

11. A return manifold comprising:
at least one input port;
at least one output port; and
means for self-regulating a transfer rate of fluidic medium flow through the return manifold.

12. The return manifold according to claim 11, wherein the means for self-regulating comprises a passively controlled thermal gate that is responsive solely to temperature changes in the fluidic medium passing through the return manifold.

13. The return manifold according to claim 11, wherein the means for self-regulating comprises an actively controlled thermal gate that is responsive to temperature changes in the fluidic medium passing through the return manifold.

14. The return manifold according to claim 11, wherein the fluidic medium comprises a liquid.

15. The return manifold according to claim 11, wherein the fluidic medium comprises a gas.

16. The return manifold according to claim 11, wherein the fluidic medium comprises a substance that undergoes a phase transition during a heat transfer cycle.

17. The return manifold according to claim 11, wherein the means for self-regulating comprises at least one variable orifice valve.

18. A method of configuring a return manifold, the method comprising the steps of:
providing a return manifold having at least one input port, at least one output port, and at least one self-regulating thermal gate disposed therein;
providing an apparatus having sections to be environmentally controlled, and that is configured such that a fluidic medium can pass independently and freely through predetermined sections of the apparatus; and
interfacing the return manifold to the apparatus such that the flow rate of the fluidic medium passing through at least one predetermined section is controlled in response to the temperature of the fluidic medium passing through the at least one thermal gate to control the operating temperature of the at least one predetermined section.

19. The method of configuring a return manifold according to claim 18, wherein at least one self-regulating thermal gate comprises a passively operated variable orifice valve such that the valve orifice size is varied solely in response to the temperature of the fluidic medium passing through the valve.

20. The method of configuring a return manifold according to claim 18, wherein at least one self-regulating thermal gate comprises an actively operated variable orifice valve such that the valve orifice size is varied in response to the temperature of the fluidic medium passing through the valve.
